(19) United States
(12) Patent Application Publication
(10) Pub. No.: US 2005/0052582 A1
(43) Pub. Date: Mar. 10, 2005

(54) Touch panel liquid crystal display

(75) Inventor: Che-Kuei Mai, Hsinchu (TW)

Correspondence Address: LIU & LIU, 811 WEST SEVENTH STREET, SUITE 1100, LOS ANGELES, CA, 90017, US

(73) Assignee: Toppoly Optoelectronics Corp.

(21) Appl. No.: 10/785,766

(22) Filed: Feb. 23, 2004

(30) Foreign Application Priority Data
Sep. 9, 2003 (TW) 92124835

(51) Int. Cl. G02F 1/1335; G09G 5/00

(52) U.S. Cl. 349/12; 345/173

(57) ABSTRACT

A touch-panel liquid crystal display is provided. The touch-panel liquid crystal display comprises a casing, a liquid crystal display module, a touch panel, a transparent conducting layer, a controlling circuit board, and a conductive buffer layer. The transparent conducting layer is disposed on the surface of the touch panel. The conductive buffer layer is disposed between the casing and the transparent conducting layer. The conductive buffer layer can be electrically connected to the casing or the conductive module casing of the liquid crystal display module so that the electrostatic charges can be released from the touch-panel LCD to ground. Hence, the electrostatic charges are effectively released from the touch panel and are prevented from entering into the controlling circuit board and the other electronic devices in the LCD.

### CROSS-REFERENCE TO RELATED APPLICATION

This application claims the priority benefit of Taiwan application serial no. 92124835, filed on Sep. 9, 2003.

### BACKGROUND OF THE INVENTION

1. Field of the Invention

This invention generally relates to a touch panel liquid crystal display, and more particularly to a touch panel liquid crystal display with electrostatic discharge protection.

2. Description of Related Art

As technology advances, digital devices such as mobile phones, PDAs, notebook computers, and tablet computers are developed to provide convenience, versatility and attractive appearances. The displays for these devices thus become indispensable interfaces between the users and the devices. Among the various types of displays, liquid crystal display (LCD) becomes the main stream for these digital devices.

Recently, to facilitate the users' input, many digital devices have adopted touch panel LCD as the inputting device rather than traditional keyboards or mice.

FIG. 1 shows a cross-sectional view of a conventional touch panel LCD. The touch panel LCD 100 includes a casing 110, a LCD module 120, a controlling circuit board 130, and a touch panel 140. The touch panel 140 is attached onto the LCD module 120. The controlling circuit board 130 is electrically connected to the LCD module 120 and the touch panel 140. The casing 110 covers the LCD module 120, the controlling circuit board 130, and the touch panel 140. Further, to prevent the touch panel 140 from being scratched by the casing 110, a buffer material 112 is set between the touch panel 140 and the casing 110. The buffer material 112 can also improve the attachment of the casing 110 and the touch panel 140.

When the user uses a finger or a touch pen to touch the touch panel 140, the touched area of the touch panel 140 will have a different electrical characteristic such as voltage drop or current change from the other areas. The different electrical characteristic is then converted into a control signal and will be sent to the controlling circuit board 130. After data processing by the CPU, a display signal is further being sent out by the controlling circuit board 130 to the LCD module 120. The LCD module 120 then displays the image on the display.

Although the touch panel manufacturing process is quite mature, the electrostatic charges generated during the panel manufacturing process or transferred from users to the touch panel may not be released from the touch panel after the touch panel and the LCD module are assembled into the LCD device. In other words, the electrostatic charges generated during the panel manufacturing process or transferred from users to the touch panel are conducted directly to the controlling circuit board or other data processing devices to induce damages to other electrical devices which cause the product non-operational.

In addition, an electrostatic grounding conductors, such as aluminum foil or conductive spongy or the like, are also introduced in the LCD module that comprising a touch panel so as to prevent the touch panel from damage. However, the volume of the aluminum foil or conductive spongy mentioned above is quite large in size.

### SUMMARY OF THE INVENTION

An object of the present invention is to provide a touch panel LCD with a structure for conducting the electrostatic charges to ground in order to protect the electronic devices in the touch panel LCD.

In brief, the touch panel of the present invention uses a transparent conducting layer and a conducting buffer material to conduct the electrostatic charges generated in the touch control panel of the touch panel liquid crystal display to ground. The path to ground can be through the casing electrically connected to ground or through the conducting casing of the LCD module. Further, the conducting buffer material of the present invention can be conducting rubber or conducting rubber with copper threads or steel threads to increase the conducting rate of the transparent conducting layer. Hence, the present invention can effectively release the electrostatic charges from the touch panel and prevent the electrostatic charges entering into the controlling circuit board and the other electronic devices in the LCD.

The present invention provides a touch panel liquid crystal display, comprising: a casing having a display opening; a liquid crystal display module disposed in the casing; a touch panel disposed in the casing, the touch panel being on the liquid crystal module, a portion of the touch panel being exposed via the display opening; a transparent conducting layer disposed on a surface of the touch panel farther away from the liquid crystal display module; and a controlling circuit board disposed in the casing, the controlling circuit board being electrically connected to the liquid crystal display module and the touch panel. It should be noted that the touch panel liquid crystal display may further comprises a conducting buffer material between the casing and the transparent conducting layer and the conducting buffer material is electrically connected to ground.

In a preferred embodiment of the present invention, the casing can be a conducting material or a non-conducting material. When the casing is a conducting material, the conducting buffer material is electrically connected to ground via the casing.

In a preferred embodiment of the present invention, the liquid crystal display module comprises: a frame; a liquid crystal panel disposed inside the frame; a back light module disposed inside the frame and below the liquid crystal panel; and a conducting module casing, wherein the frame, the liquid crystal panel, and the back light module are fixed into the conducting module casing. It is important to note that the conducting buffer material is electrically connected to ground via the conducting module casing.

In a preferred embodiment of the present invention, the touch panel comprises: a first substrate; a first conducting layer disposed on the surface of the first substrate; a second substrate disposed above the first substrate; a second conducting layer disposed on the surface of the second substrate adjacent to the first substrate; a plurality of spacers disposed between the first conducting layer and the second conducting layer; a first bus disposed on the first conducting layer and surrounding the plurality of spacers; a second bus disposed above the first bus; and an adhesive layer disposed between the first bus and the second bus to insulate the first bus and the second bus.

In a preferred embodiment of the present invention, the touch panel further comprises an anti-scratch layer between the second substrate and the transparent conducting layer.

In a preferred embodiment of the present invention, the first and second substrates include at least one of rigid substrate and flexible substrate. The first and second substrates include at least one of glass, plastic, and polyethylene tetrephthalate (PET).

In a preferred embodiment of the present invention, the first and second buses are formed with a material that includes silver (Ag), while the spacers can be dielectric materials such as silicon oxide or silicon nitride.

In a preferred embodiment of the present invention, the transparent conducting layer includes at least one of ITO and IZO; the conducting buffer material includes a conducting rubber. Further, conducting threads, such as, steel threads or copper threads can be added to the conducting buffer material.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF THE DRAWINGS

FIG. 1 shows a cross-sectional view of a conventional touch panel LCD.

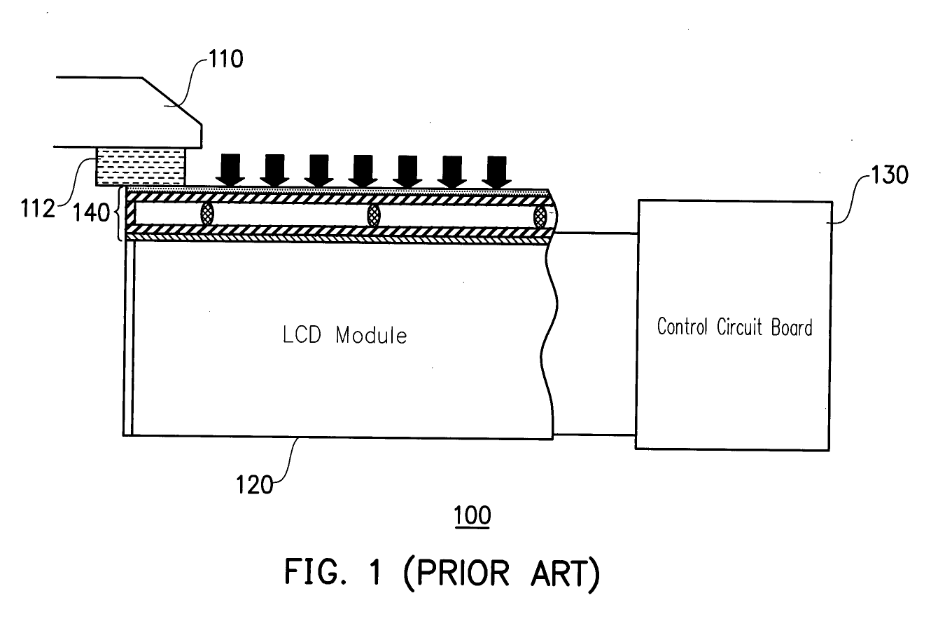

FIG. 2 shows a cross-sectional view of a touch panel LCD in accordance with the first embodiment of the present invention.

FIG. 3 shows the assembling process for the touch panel of the touch panel LCD in accordance with the present invention.

FIG. 4 shows a cross-sectional view of a touch panel LCD in accordance with the second embodiment of the present invention.

FIG. 5 shows a top view of a touch panel LCD in accordance with the present invention.

FIG. 6 is a schematic diagram of an electronic device having a display with a touch panel of the present invention.

### DESCRIPTION OF THE PREFERRED EMBODIMENTS

The following description is of the best-contemplated mode of carrying out the invention. This description is made for the purpose of illustrating the general principles of the invention and should not be taken in a limiting sense. The scope of the invention is best determined by reference to the appended claims.

It is noted that the description hereinbelow refers to various layers arranged on, above or overlying other layers, to describe the relative positions of the various layers. References to “on”, “above”, “overlying”, or other similar languages, are not limited to the interpretation of one layer being immediately adjacent another layer. There may be intermediate or interposing layers, coatings, or other structures present, and associated process steps present, which are not shown or discussed herein, but could be included to accomplish the intended purpose without departing from the scope and spirit of the invention disclosed herein. Similar, references to structures adjacent, between or other positional references to other structures merely describe the relative positions of the structures, with or without intermediate structures.

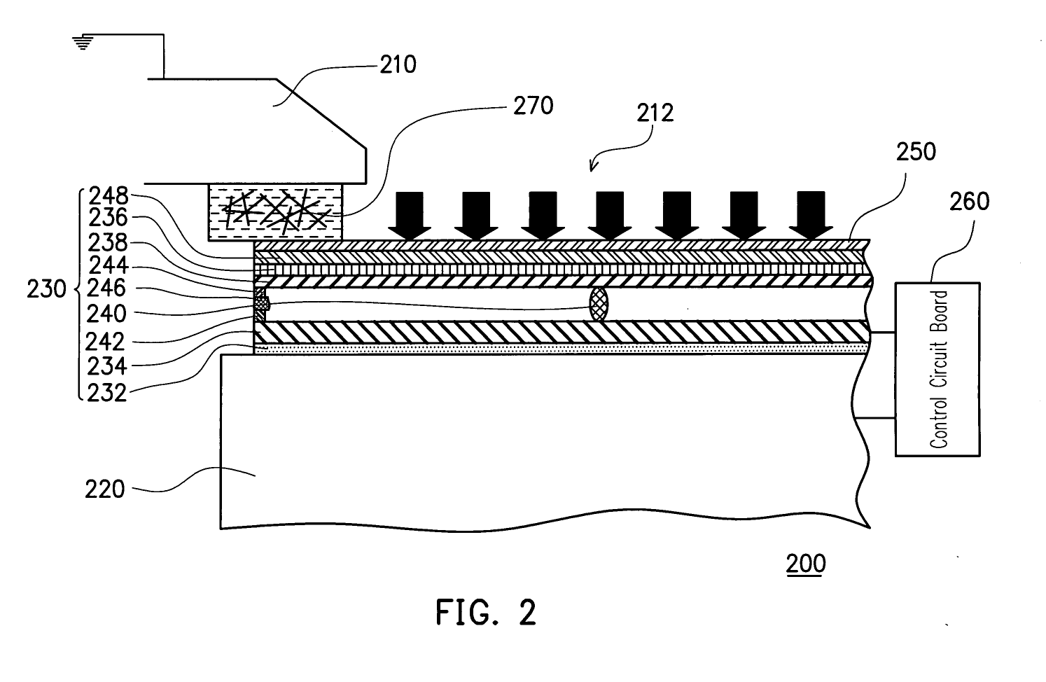

FIG. 2 shows a cross-sectional view of a touch panel LCD in accordance with the first embodiment of the present invention. Referring to FIG. 2, the touch panel LCD 200 includes a casing 210, a LCD module 220, a touch panel 230, a transparent conducting layer 250, a controlling circuit board 260, and a conducting buffer layer 270.

The touch panel 230 is positioned above the LCD module 220 and below the transparent conducting layer 250. The material of the transparent conducting layer 250 is ITO or IZO. The controlling circuit board 260 is electrically connected to the LCD module 220 and the touch panel 230 to receive the control signal from the touch panel 230 and will be send the display signal to the LCD module 220.

The casing 210 is disposed outside the touch panel LCD 200 to cover the above-mentioned devices. In addition, the casing 210 can be a conducting material electrically connected to ground. Further, the casing 210 has a display opening 212 so that a portion of the touch panel 230 is exposed via the opening 212.

The conducting buffer material 270 is disposed between the transparent conducting layer 250 and the casing 210 to electrically connect the transparent conducting layer 250 and the casing 210. It should be noted that the conducting buffer material 270 may be any pliant or compressible material, natural or artificial, that has conductive properties to serve as a conductive buffer material between the casing 210 and the conducting layer 250. The material may include, for example, a conducting elastomeric material such as conducting rubber, or a pliant fiberous material such as leather. The pliant material may be made conductive by providing a matrix of conductive additives within a substrate of pliant non-conductive material. For example, the conductive additives may include a matrix of conducting threads, conductive wires, conductive beads, conductive ink, conductive inserts and/or other conductive elements. Alternative to a pliant non-conductive material that includes a matrix of conductive elements, the conductive buffer material may be structured in the form of compressible conductive spring (e.g., a metal layer spring) between the casing 210 and the conductive layer 250.

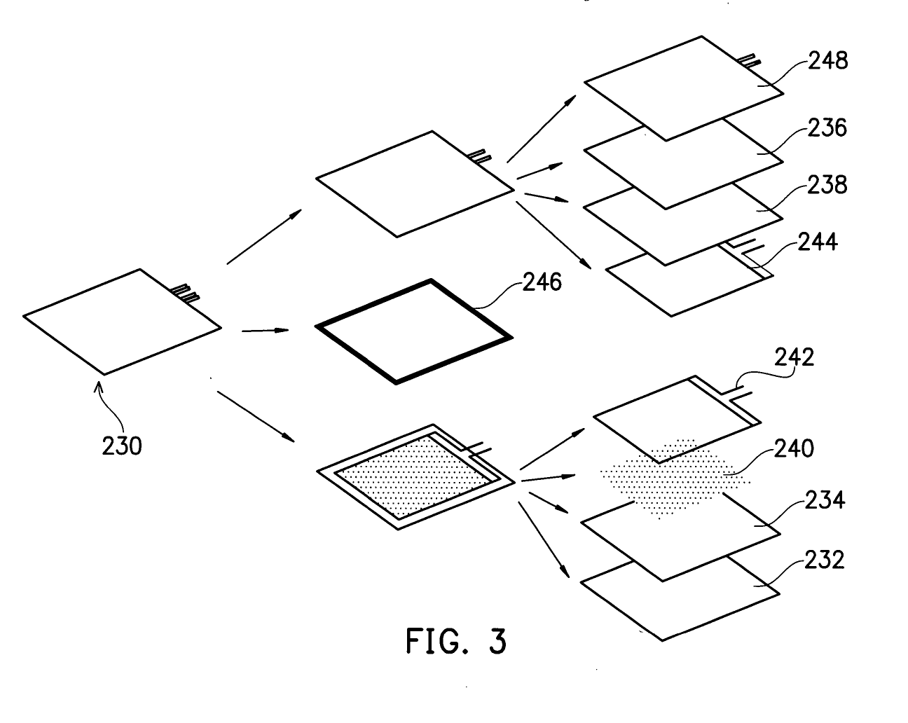

FIG. 3 shows the assembling process for the touch panel of the touch panel LCD in accordance with the present invention. Referring to FIGS. 2 and 3, the touch panel 230 includes a first substrate 232, a first conducting layer 234, a second substrate 236, a second conducting layer 238, a plurality of spacers 240, a first bus 242, a second bus 244, an adhesive layer 246, and an anti-scratch layer 248.

The first and second substrates 232 and 236 can be flexible substrates such as polyester so that the substrates are tolerable to deformation to some extent. The second substrate 236 is disposed above the first substrate 232. The first and second conducting layers 234 and 238 are disposed on the surfaces of the first and second substrates 232 and 236 respectively. The anti-scratch layer 248 is between the second substrate 236 and the transparent conducting layer 250.

A plurality of spacers 240 is disposed between the first conducting layer 234 and the second conducting layer 238 to support the first and second conducting layers 234 and 238. The material of the spacers 240 is a dielectric material such as silicon oxide or silicon nitride. Further, the first and second buses 242 and 244 are formed with a material that includes silver (Ag). The first bus 242 is disposed on the first conducting layer 234 and surrounds the plurality of spacers 240. The second bus 244 is disposed above the first bus 242. The adhesive layer 246 is disposed between the first bus 242 and the second bus 246 to insulate the first bus 242 and the second bus 246.

When a finger or an object such as a touch pen imposes a force upon the transparent conducting layer 250, the touched area of the second conducting layer 238 is deformed so that an electrical characteristic such as a voltage drop or a current change is generated between the first and second conducting layers 234 and 238. Hence, an induced current is generated on the first and second buses 242 and 244 as the control signal that is being inputted into the controlling circuit board 260.

In the above first embodiment, the touch panel uses a transparent conducting layer and a conducting buffer material to conduct the electrostatic charges to ground. For example, the external ground terminal can be a chassis ground or a ground terminal of a touch panel controller, of a display, or an electronic apparatus. Because the casing is a conducting material, the electrostatic charges can be released to ground through the casing electrically connected to ground. The conductive layer 250 need not extend completely across or completely cover the active area of the touch panel.

Although some touch panel LCDs may have plastic casings, the electrostatic grounding aspect of the touch panel LCD of the present invention can still be applied by using the casing of the other devices such as LCD module or controlling circuit board to electrically connect to ground.

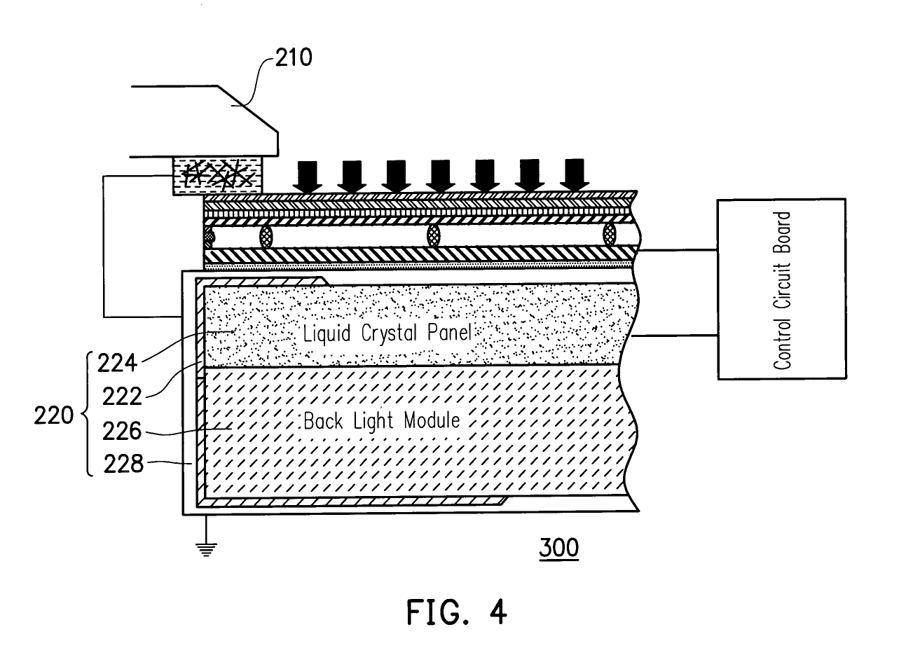

FIG. 4 shows a cross-sectional view of a touch panel LCD in accordance with the second embodiment of the present invention. Referring to FIG. 4, the second embodiment is the same as the first embodiment except that the casing 210 of the touch panel LCD 300 is not conducting material. It should be noted that the LCD module 220 includes a frame 222, a liquid crystal panel 224, a back light module 226, and a bezel 228. The liquid crystal panel 224 and the back light module 226 are disposed inside the frame 222. The back light module 226 is disposed below the liquid crystal panel 224. The frame 222, the liquid crystal panel 224, and the backlight module 226 are fixed into the bezel 228. The bezel 228 is a conducting casing electrically connected to ground. Hence, the conducting buffer material 270 can be electrically connected to ground via the bezel 228.

In the above first embodiment, the touch panel uses a transparent conducting layer and a conducting buffer material to conduct the electrostatic charges to ground. Because the bezel is a conducting material, the electrostatic charges can be released to ground through the bezel electrically connected to ground.

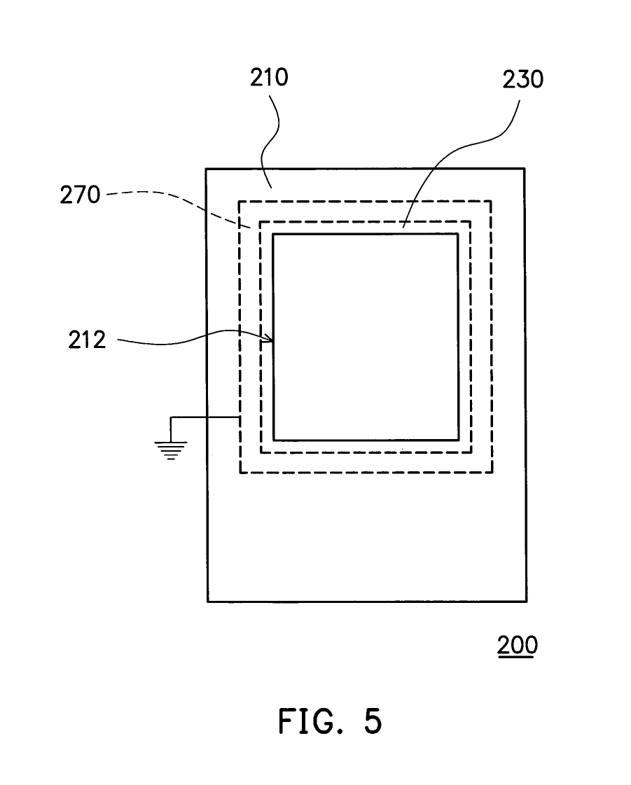

FIG. 5 shows a top view of a touch panel LCD in accordance with the present invention. Referring to FIG. 5, the casing 210 is disposed above the touch panel 230 and exposed the display opening 212. The conducting buffer material 270 is disposed between the touch panel 230 and the casing 210. If the casing 210 is a conducting material electrically connected to ground, the conducting buffer material 270 can be electrically connected to the casing 210 so that the electrostatic charges can be conducted to ground. If the casing 210 is a non-conducting material electrically connected to ground, the conducting buffer material 270 can be electrically connected to the casing of the other devices such as LCD module (as shown in FIG. 2) or controlling circuit board so that the electrostatic charges can be conducted to ground via the casing of those devices. The conducting buffer material 270 need not be configured in a closed loop as shown in FIG. 5. The conducting buffer material 270 may be configured in separate sections grounded and distributed around the active area of the touch panel 200, or in a continuous section that is less than a complete closed loop, such as an open or partial loop, such as an U-shaped or C-shaped loop.

Further, the conducting buffer material of the present invention can be conducting rubber or conducting rubber with copper threads or steel threads to increase the electric conductivity of the transparent conducting layer. The transparent conducting layer includes at least one of indium tin oxide (ITO) and indium zinc oxide (IZO). The first and second substrates include at least one of rigid substrate and flexible substrate. The first and second substrates include at least glass, plastic or polyethylene tetrephthalate (PET). Hence, in accordance to the present invention, the electrostatic charges can be effectively released from the touch panel and prevented from entering into the controlling circuit board and the other electronic devices in the LCD.

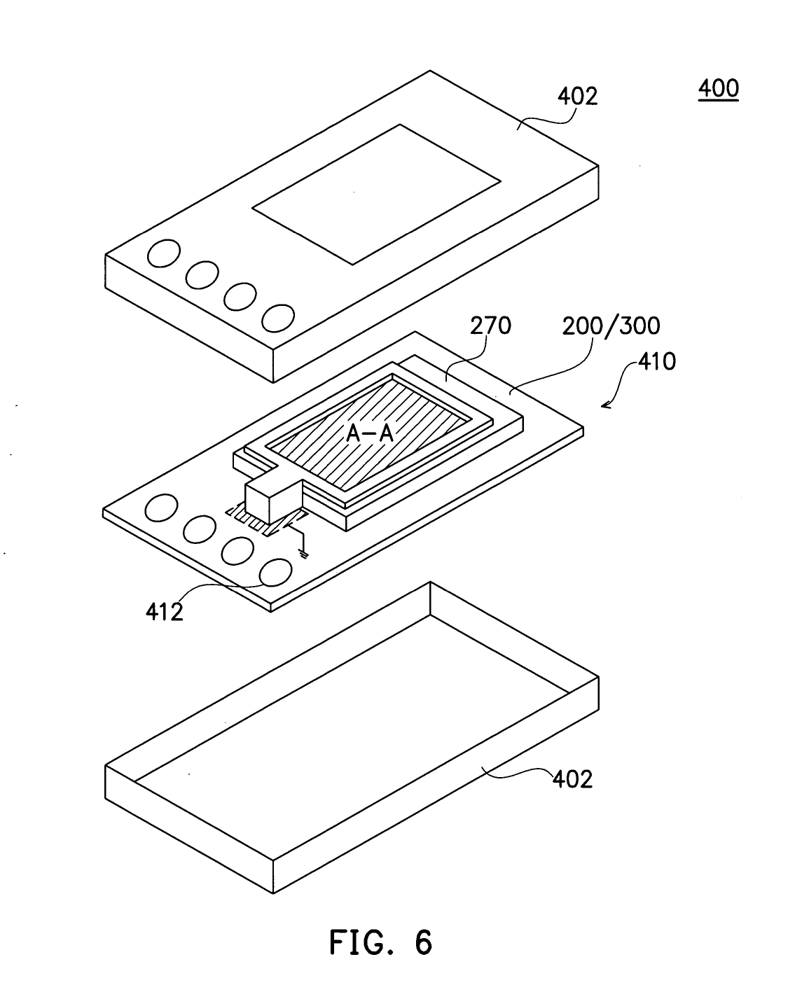

FIG. 6 schematically shows an electronic device 400 deploying a display system 410 having the touch panel 200 or 300 described above. The electronic device 400 may be a portable device such as a PDA, notebook computer, tablet computer, cellular phone, or a display monitor device, etc. For example, electronic device 400 such as a PDA includes a housing 402, the display system 410 having the touch panel 200 or 300, device controller 412, etc. The grounding conductive buffer material 270 is coupled to the chassis ground of the electronic device 400, such as the housing 402 of the electronic device 400.

Further, the touch panel in accordance with the present invention may be deployed in electronic devices as an user input device, not as an integral part of a display systems. For example, the inventive touch panel may be deployed in electronic devices, as standalone input devices, such as writing or drawing pads, tablets, boards or other types of input devices requiring a user touch or stylus input, or peripheral devices which may be a part of a larger electronic device or which may be operatively coupled to another electronic device, such as a computing device or a machine.

While the inventive touch panel is described above in connection with an LCD display system, the present invention may be deployed in other types of display systems, such as systems deploying a plasma display element, or a cathode ray tube display element.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

1. A touch panel liquid crystal display, comprising:
a casing having a display opening;
a liquid crystal display module disposed in said casing;
a touch panel disposed in said casing, said touch panel being on said liquid crystal module, a portion of said touch panel being exposed via said display opening;
a transparent conducting layer disposed on a surface of said touch panel farther away from said liquid crystal display module; and
a controlling circuit board disposed in said casing, said controlling circuit board being electrically connected to said liquid crystal display module and said touch panel.

2. The touch panel liquid crystal display according to claim 1, wherein said casing includes a conducting material.

3. The touch panel liquid crystal display according to claim 2 further comprising a conducting buffer material disposed between said casing and said transparent conducting layer, said conducting buffer material being electrically connected to ground via said casing.

4. The touch panel liquid crystal display according to claim 1, wherein said casing include a non-conducting material.

5. The touch panel liquid crystal display according to claim 1, wherein said liquid crystal display module comprises:
a frame;
a liquid crystal panel disposed in said frame;
a back light module disposed in said frame and below said liquid crystal panel; and
a conducting module casing, wherein in said frame, said liquid crystal panel, and said back light module being fixed into said conducting module casing.

6. The touch panel liquid crystal display according to claim 5 further comprising a conducting buffer material disposed between said casing and said transparent conducting layer, wherein said conducting buffer material is electrically connected to ground via said casing.

7. The touch panel liquid crystal display according to claim 1, wherein said touch panel comprises:
a first substrate;
a first conducting layer disposed on a surface of said first substrate;
a second substrate disposed above said first substrate;
a second conducting layer disposed on a surface of said second substrate adjacent to said first substrate;
a plurality of spacers disposed between said first conducting layer and said second conducting layer;
a first bus disposed on said first conducting layer and surrounding said plurality of spacers;
a second bus disposed above said first bus; and
an adhesive layer disposed between said first bus and said second bus to insulate said first bus and said second bus.

8. The touch panel liquid crystal display according to claim 7, wherein said touch panel further comprises an anti-scratch layer disposed between said second substrate and said transparent conducting layer.

9. The touch panel liquid crystal display according to claim 7, wherein said first substrate and said second substrate include at least one of rigid substrate and flexible substrate.

10. The touch panel liquid crystal display according to claim 7, wherein said first substrate and said second substrate include at least one of glass, plastic, and polyethylene tetrephthalate (PET).

11. The touch panel liquid crystal display according to claim 7, wherein a material of said first bus and said second bus includes silver (Ag).

12. The touch panel liquid crystal display according to claim 7, wherein said plurality of spacers includes a dielectric material.

13. The touch panel liquid crystal display according to claim 1, wherein said transparent conducting layer includes at least one of indium tin oxide (ITO) and indium zinc oxide (IZO).

14. The touch panel liquid crystal display according to claim 3, wherein said conducting buffer material includes a conducting rubber.

15. The touch panel liquid crystal display according to claim 3 further comprising a plurality of conducting threads in said conducting buffer material.

16. The touch panel liquid crystal display according to claim 6, wherein said conducting buffer material includes a conducting rubber.

17. The touch panel liquid crystal display according to claim 6 further comprising a plurality of conducting threads in said conducting buffer material.

18. An electronic device, comprising:
a touch panel display as in claim 1; and
a device controller coupled to the display system and configured to process data corresponding to an image to be rendered by the display system.

19. The electronic device according to claim 18, further comprising at least one of a portable device, a display monitor and a user input device.

20. A touch panel input device, comprising:
a touch panel; and
a grounding conductor conductively coupled to said touch panel and configured to be conductively coupled to an external ground.
